(19) United States
(12) Patent Application Publication
(10) Pub. No.: US 2021/0234451 A1
(43) Pub. Date: Jul. 29, 2021

(54) MULTI-DEGREE-OF-FREEDOM ELECTROMAGNETIC MACHINE WITH PAYLOAD ATTACHMENT ASSEMBLY

(71) Applicant: HONEYWELL INTERNATIONAL INC., Morris Plains, NJ (US)

(72) Inventors: Deepak Pitambar Mahajan, Bangalore (IN); Varun Anand, Bangalore (IN); Renukaprasad N, Bangalore (IN); Ramakrishna Rao P.V, Bangalore (IN); Govind Yadav, Bangalore (IN); Subhashree Rajagopal, Bangalore (IN); Jijo Thomas, Bangalore (IN)

(73) Assignee: HONEYWELL INTERNATIONAL INC., Morris Plains, NJ (US)

(21) Appl. No.: 17/004,428

(22) Filed: Aug. 27, 2020

(30) Foreign Application Priority Data
Jan. 29, 2020 (IN) 202011003908

(51) Int. Cl. H02K 41/03; F16M 13/04; G03B 17/56

(52) U.S. Cl. CPC H02K 41/03; H02K 2201/18; G03B 17/561; F16M 13/04

(57) ABSTRACT

A multi-degree-of-freedom electromagnetic machine includes a spherical stator, an armature, a payload mount assembly, and a payload. The spherical stator has a first axis of symmetry, a second axis of symmetry, and a third axis of symmetry that are disposed perpendicular to each other. The armature is spaced apart from, and surrounds at least a portion of, the spherical stator, and is mounted for rotation about the first and second axes of symmetry. The payload is spaced apart from the spherical stator and the armature and is coupled to the payload mount assembly and is mounted to rotate about a payload rotational axis that is parallel to the first axis of symmetry and perpendicular to the second axis of symmetry. The payload is disposed such that its center of gravity is at a position where the second axis of symmetry and the payload rotational axis intersect.

### CROSS REFERENCE TO RELATED APPLICATION

This application claims priority to Indian Provisional Patent Application No. 202011003908, filed Jan. 29, 2020, the entire content of which is incorporated by reference herein.

### TECHNICAL FIELD

The present invention generally relates to electromagnetic machines, such as spherical motors, and more particularly relates to electromagnetic machines with payload attachment assemblies.

### BACKGROUND

In recent years, unmanned autonomous vehicle (UAV), robotic, and surveillance camera industries have grown relatively quickly. Many devices within these industries rely on DC motors effectuate various motions. In the context of UAVs that include a camera, actuators are used to move the camera, in two degrees-of-freedom, to a specific position and to remain stable in that position when the UAV is moving. Currently, motion in each degree-of-freedom is implemented using a separate DC motor.

Various attempts have been made to develop electromagnetic machines (e.g., motors/actuators) that can rotate in multiple degrees-of-freedom. The electromagnetic machines heretofore developed suffer certain drawbacks. For example, the machines can be relatively large and relatively expensive to manufacture, and can be relatively complex.

Hence, there is a need for multi-degree-of-freedom machine that is relatively small and inexpensive, as compared to known designs, and that can independently or synchronously generate torque and/or rotate along two perpendicular axes. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a multi-degree-of-freedom electromagnetic machine includes a spherical stator, a first coil, a second coil, a third coil, an armature, a payload mount assembly, and a payload. The spherical stator has a first axis of symmetry, a second axis of symmetry, and a third axis of symmetry. The first, second, and third axes of symmetry are disposed perpendicular to each other. The first coil is wound on the spherical stator about the first axis of symmetry, the second coil is wound on the spherical stator about the second axis of symmetry, and the third coil is wound on the spherical stator about the third axis of symmetry. The armature is spaced apart from, and surrounds at least a portion of, the spherical stator, and is mounted for rotation about the first axis of symmetry and second axis of symmetry. The payload mount assembly is coupled to the armature and to the spherical stator. The payload is spaced apart from the spherical stator and the armature and is coupled to the payload mount assembly. The payload is mounted to rotate, relative to at least a portion of the payload mount assembly, about a payload rotational axis that is parallel to the first axis of symmetry and perpendicular to the second axis of symmetry. The payload is disposed such that its center of gravity is at a position where the second axis of symmetry and the payload rotational axis intersect. The armature is rotatable relative to at least a portion of the payload mount assembly about the first axis of symmetry, and the armature and payload mount assembly are rotatable relative to the spherical stator about the second axis of symmetry. When the armature rotates about the first axis of symmetry, the payload simultaneously rotates about the payload rotational axis, and when the armature rotates about the second axis of symmetry, the payload mount assembly and the payload simultaneously rotate about the second axis of symmetry.

In another embodiment, a multi-degree-of-freedom electromagnetic machine includes a spherical stator, a first coil, a second coil, a third coil, an armature, a payload mount assembly, a bracket arm, a first pulley, a second pulley, a belt and a payload. The spherical stator has a first axis of symmetry, a second axis of symmetry, and a third axis of symmetry. The first, second, and third axes of symmetry are disposed perpendicular to each other. The first coil is wound on the spherical stator about the first axis of symmetry, the second coil is wound on the spherical stator about the second axis of symmetry, and the third coil is wound on the spherical stator about the third axis of symmetry. The armature is spaced apart from, and surrounds at least a portion of, the spherical stator, and is mounted for rotation about the first axis of symmetry and second axis of symmetry. The bracket arm is coupled to the spherical stator and to the armature. The first pulley is rotationally mounted on the bracket arm and is coupled to the armature. The first pulley is rotatable, relative to the bracket arm, about the first axis of symmetry. The second pulley is spaced apart from the first pulley and is rotationally mounted on the bracket arm. The second pulley is rotatable, relative to the bracket arm, about a payload rotational axis that is parallel to the first axis of symmetry and is perpendicular to the second axis of symmetry. The belt is mounted on the first and second pulleys to transfer torque from the first pulley to the second pulley, whereby rotation of the first pulley about the first axis of symmetry causes rotation of the second pulley and the payload about the payload rotational axis. The payload is coupled to the second pulley and is rotatable therewith about the payload rotational axis. The payload is disposed such that its center of gravity is at a position where the second axis of symmetry and the payload rotational axis intersect. The armature is rotatable relative to the bracket arm about the first axis of symmetry, and the armature and bracket arm are rotatable relative to the spherical stator about the second axis of symmetry. When the armature rotates about the first axis of symmetry, the payload simultaneously rotates about the payload rotational axis, and when the armature rotates about the second axis of symmetry, the bracket arm and the payload simultaneously rotate about the second axis of symmetry.

In yet another embodiment, a multi-degree-of-freedom electromagnetic machine includes a spherical stator, a first coil, a second coil, a third coil, an armature, a lever arm, and a payload. The spherical stator has a first axis of symmetry, a second axis of symmetry, and a third axis of symmetry. The first, second, and third axes of symmetry are disposed perpendicular to each other. The first coil is wound on the spherical stator about the first axis of symmetry, the second coil is wound on the spherical stator about the second axis of symmetry, and the third coil is wound on the spherical stator about the third axis of symmetry. The armature is spaced apart from, and surrounds at least a portion of, the spherical stator, and is mounted for rotation about the first axis of symmetry and second axis of symmetry. The lever arm is rotationally coupled to the armature. The payload is spaced apart from the spherical stator and the armature and is rotationally coupled to the lever arm. The payload is mounted to rotate about a payload rotational axis that is parallel to the first axis of symmetry and perpendicular to the second axis of symmetry. The payload is disposed such that its center of gravity is at a position where the second axis of symmetry and the payload rotational axis intersect. The armature is rotatable relative to the payload mount assembly about the first axis of symmetry, and the armature and lever arm are rotatable relative to the spherical stator about the second axis of symmetry. When the armature rotates about the first axis of symmetry, the payload simultaneously rotates about the payload rotational axis, and when the armature rotates about the second axis of symmetry, the lever arm and the payload simultaneously rotate about the second axis of symmetry.

Furthermore, other desirable features and characteristics of the multi-degree-of-freedom electromagnetic machine will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of one embodiment of a multi-degree-of-freedom electromagnetic machine;

FIG. 2 depicts one embodiment of a spherical stator that may be used in the electromagnetic machine of FIG. 1;

FIG. 3 depicts one embodiment of a rotor that may be used in the electromagnetic machine of FIG. 1;

FIG. 4 depicts a plan view of one particular physical implementation of the electromagnetic machine of FIG. 1;

FIGS. 5-7 depict the range of motion of the electromagnetic machine depicted in FIG. 4;

FIGS. 8 and 9 depict a plan view and a side view, respectively, of another particular physical implementation of the electromagnetic machine of FIG. 1;

FIGS. 10-12 depict the range of motion of the electromagnetic machine depicted in FIGS. 8 and 9; and

FIGS. 13 and 14 depict a plan view and an exploded view, respectively, of another particular physical implementation of the electromagnetic machine of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

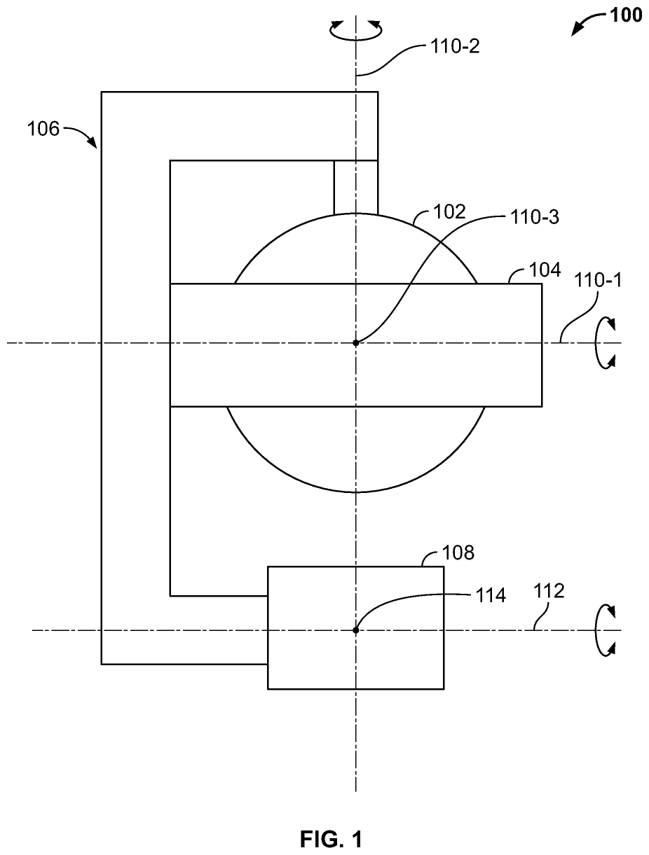

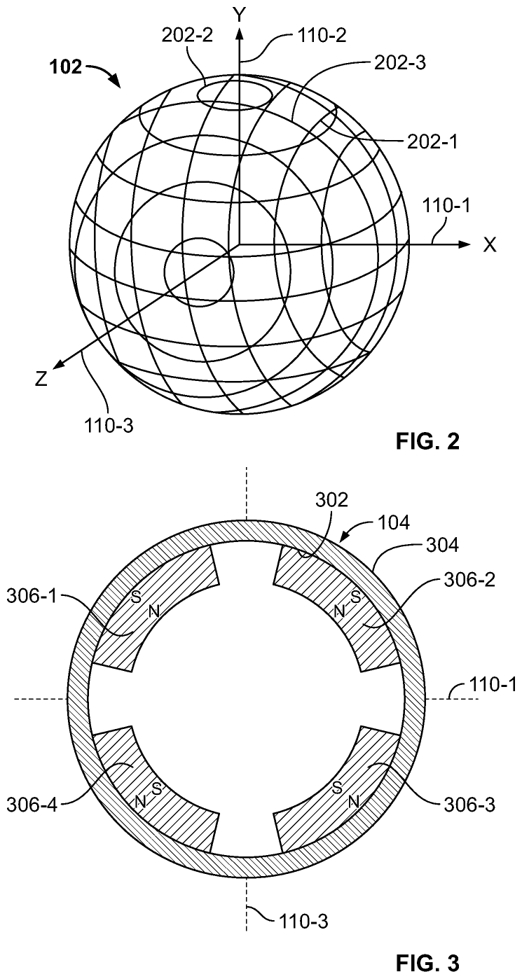

Referring now to FIG. 1, a functional block diagram of one embodiment of a multi-degree-of-freedom electromagnetic machine 100 is depicted. The depicted machine includes a spherical stator 102, an armature 104, a payload mount assembly 106, and a pay load 108. The spherical stator 102, an example embodiment of which is depicted in FIG. 2, includes a first axis of symmetry 110-1, a second axis of symmetry 110-2, a third axis of symmetry 110-3, all of which are disposed perpendicular to each other.

As FIG. 2 depicts more clearly, the spherical stator 102 also has a plurality of coils 202 wound thereon. In the depicted embodiment, these include a first coil 202-1, a second coil 202-2, and a third coil 202-3. It will be appreciated, however, that in some embodiments the electromagnetic machine 100 may be implemented with only two coils instead of three. The first coil 202-1 is wound on the spherical stator 102 about the first axis of symmetry 110-1, the second coil 202-2 is wound on the spherical stator 102 about the second axis of symmetry 110-2, and the third coil 202-3, when included, is wound on the spherical stator 102 about the third axis of symmetry 110-3-3. It should be noted that a sphere has an infinite number of axes of symmetry. Thus, the first, second, and third axes of symmetry 110-1, 110-2, 110-3, could be any one of these axes of symmetry, so long as all three axes of symmetry are perpendicular to each other.

Returning now to FIG. 1, it is seen that the armature 104 is spaced apart from, and surrounds at least a portion of, the spherical stator 102. The armature 104 is mounted for rotation about the first axis of symmetry 110-1 and second axis of symmetry 110-2. The specific manner in which the armature 104 is mounted to allow this rotation may vary, and will be discussed further below. The armature 104, an embodiment of which is depicted in simplified form in FIG. 3, includes an inner surface 302 and an outer surface 304. A plurality of magnets 306 are coupled to, and extend inwardly from, the inner surface 302 of the armature 104. In the depicted embodiment, the machine 100 includes four magnets—a first magnet 306-1, a second magnet 306-2, a third magnet 306-3, and a fourth magnet 306-4. It will be appreciated, however, that in other embodiments more or less than four magnets 306 may be used. It will additionally be appreciated that the magnets 306 may be variously shaped and dimensioned, and the magnets 306 may be variously disposed. For example, in the depicted embodiment the magnets 306 are generally arc-shaped, but in other embodiments the magnets 306 may be semi-spherically shaped, wedge-shaped, or any one of numerous other shapes if needed or desired. It will additionally be appreciated that the arc length of the magnets 306 may be varied, and that the magnets 306 may be permanent magnets or, if needed or desired, electromagnets.

Regardless of the shape and dimensions, however, the magnets 306 are preferably arranged such that the polarity of the first and second magnets 306-1, 306-2 relative to the spherical stator 102 is opposite to the polarity of the third and fourth magnets 306-3, 306-4. For example, in the embodiment depicted in FIG. 3, the north poles (N) of the first and second magnets 306-1, 306-2 are disposed closer to the spherical stator 102, whereas the south poles (S) of the third and fourth magnets 306-3, 306-4 are disposed closer to the spherical stator 102.

The payload mount assembly 106 is coupled to the spherical stator 102, the armature 104, and to the payload 108. The payload 108, which is spaced apart from the spherical stator 102 and the armature 104, is mounted to rotate, relative to at least a portion of the payload mount assembly 106, about a payload rotational axis 112. As FIG. 1 depicts, the payload rotational axis 112 is parallel to the first axis of symmetry 110-1 and is perpendicular to the second axis of symmetry 110-2. In a preferred embodiment, such as the one depicted in FIG. 1, the payload 108 is disposed such that its center of gravity 114 is at the position where the second axis of symmetry 110-2 and the payload rotational axis 112 intersect. This ensures the minimum amount of torque is needed to cause the payload 108 to rotate about the payload rotational axis 112. It will be appreciated that the payload 108 may be any one of numerous types of devices now known or developed in the future. Some non-limiting examples of suitable payloads include any one of numerous types of compasses, cameras (e.g., DSLR, thermal, or IR cameras), or laser guiding/pointing devices, just to name a few.

Regardless of the specific type of payload 108, the payload mount assembly 106 is configured such that the armature 104 is rotatable relative to the payload mount assembly 106 about the first axis of symmetry 110-1, and the armature 104 and payload mount assembly 106 are rotatable relative to the spherical stator 102 about the second axis of symmetry 110-2. The payload mount assembly 106 is also configured such that when the armature 104 rotates about the first axis of symmetry 110-1, the payload 108 simultaneously rotates about the payload rotational axis 112, and when the armature 104 rotates about the second axis of symmetry 110-2, the payload mount assembly 106 and the payload 108 simultaneously rotate about the second axis of symmetry 110-2.

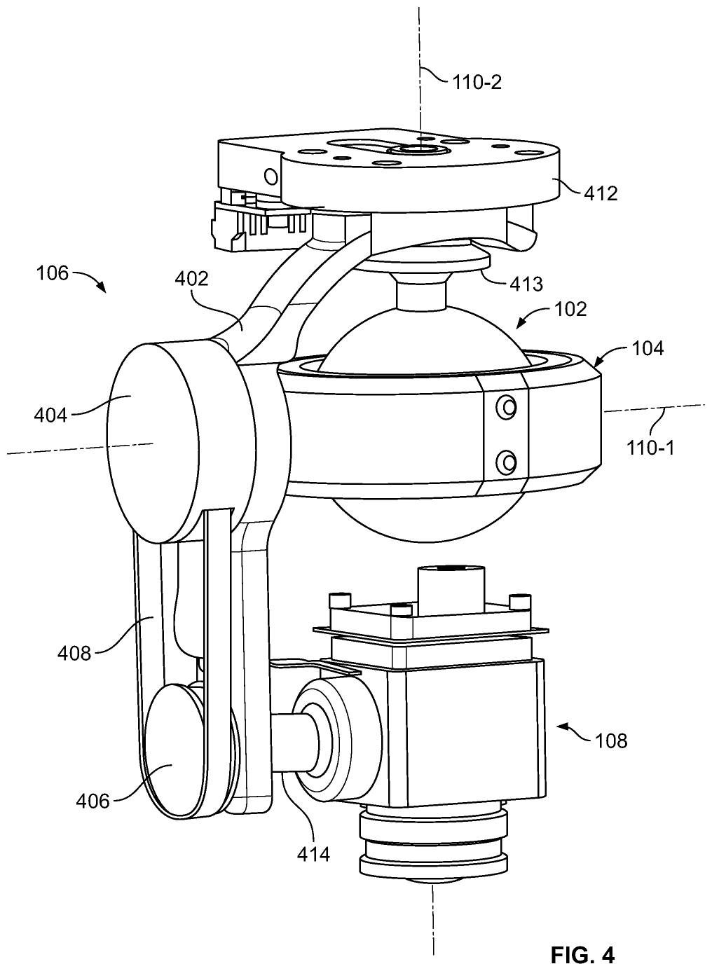

It will be appreciated that the payload mount assembly 106 may be variously implemented to provide the above-described functionality. Some specific implementations are depicted in FIGS. 4-13 and will now be described, beginning first with the embodiment depicted in FIGS. 4-7.

Referring first to FIG. 4, which is a plan view of an embodiment of the electromagnetic machine 100, the payload mount assembly 106 includes a bracket arm 402, a first pulley 404, a second pulley 406, and a belt 408. The bracket arm 402 is coupled to the spherical stator 102 and to the armature 104. More specifically, at least in the depicted embodiment, the bracket arm 402 is rotationally coupled, via any one of numerous types of suitable non-illustrated hardware, to a mount plate 412. The mount plate 412, which is adapted to be fixedly mounted to a non-illustrated structure is also non-rotationally coupled, via suitable mounting hardware 413, to the spherical stator 102. Thus, when the armature 104 is caused to rotate about the second rotational axis 110-2, the payload mount assembly 106 (e.g., bracket arm 402, first pulley 404, second pulley 406, and belt 408), and thus the payload 108, also rotate about the second rotational axis 110-2.

The first pulley 404 is rotationally mounted on the bracket arm 402 and is coupled to the armature 104. The first pulley 404 is rotatable, relative to the bracket arm 402, about the first axis of symmetry 110-1. The second pulley 406 is spaced apart from the first pulley 404 and is also rotationally mounted on the bracket arm 402. The second pulley 406 is, however, coupled to the payload 108 and is rotatable, relative to the bracket arm 402, about the payload rotational axis 112. In the depicted embodiment, a shaft 414 is coupled between the second pulley 406 and the payload 108. As may be appreciated, any one of numerous types of suitable non-illustrated hardware may be used to rotationally mount the first pulley 404 and the second pulley 406 on the bracket arm 402.

The belt 408 is mounted on the first and second pulleys 404, 406 and transfers torque from the first pulley 404 to the second pulley 406. As a result, when the armature 104 rotates about the first axis of symmetry 110-1, it imparts a torque to the first pulley 404 causing it to also rotate about the first axis of symmetry 110-1. The first pulley 404, via the belt 408, imparts a torque to the second pulley 406 causing it, and concomitantly the payload 108, to rotate about the payload rotational axis 112.

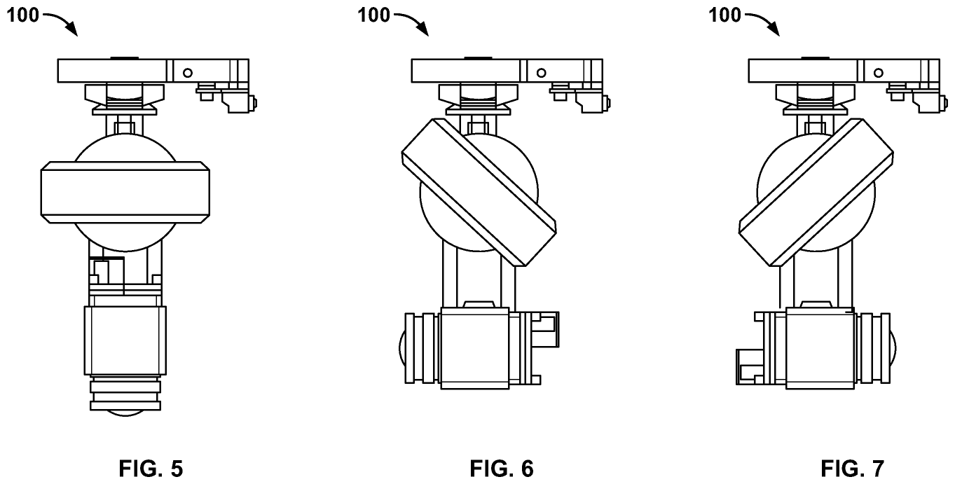

As FIG. 4 also depicts, the first and second pulleys 404, 406 have different diameters. More specifically, the first pulley 404 has a first diameter and the second pulley 406 has a second diameter, and the first diameter is greater than the second diameter. Because of this, and as is generally known to persons of ordinary skill in the art, when the first pulley 404 is rotated through a first angular displacement, the second pulley 406 will be rotated through a second angular displacement that is greater than the first angular displacement. In one embodiment, and as shown more clearly in FIGS. 5-7, the first and second diameters are such that when the armature 104, and thus the first pulley 402, is rotated through 90-degrees of rotation about the first axis of symmetry 110-1 (e.g., from a reference position (FIG. 5) to 45-degrees in one rotational direction (FIG. 6) and to 45-degrees in the opposite rotational direction (FIG. 7)), the second pulley 406, and thus the payload 108, is rotated through 180-degrees of rotation about the payload rotational axis 112. This can be accomplished by, for example, making the first diameter twice that of the second diameter.

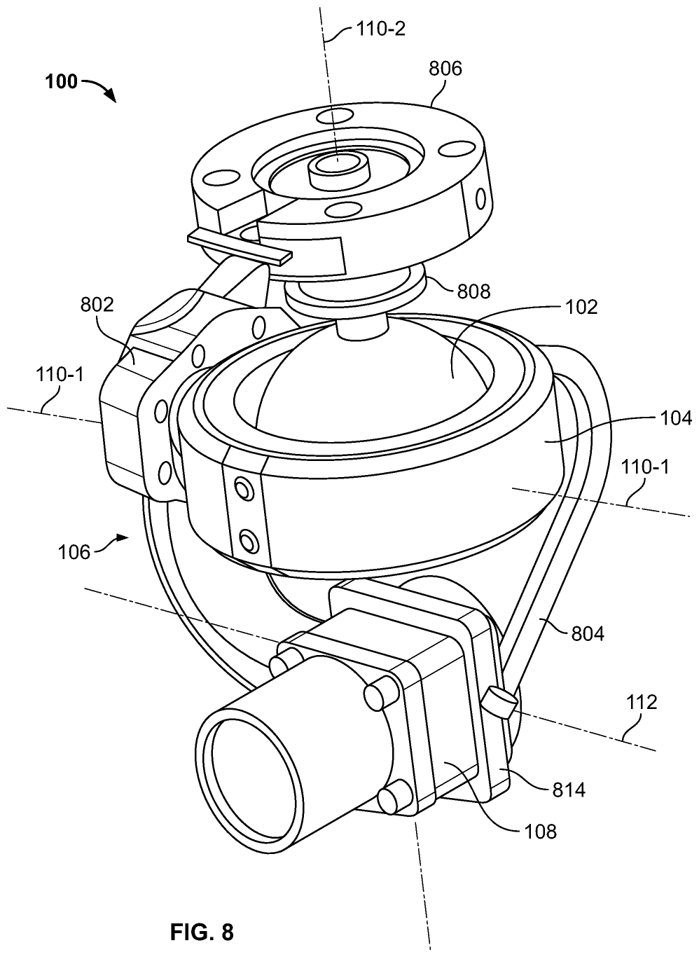

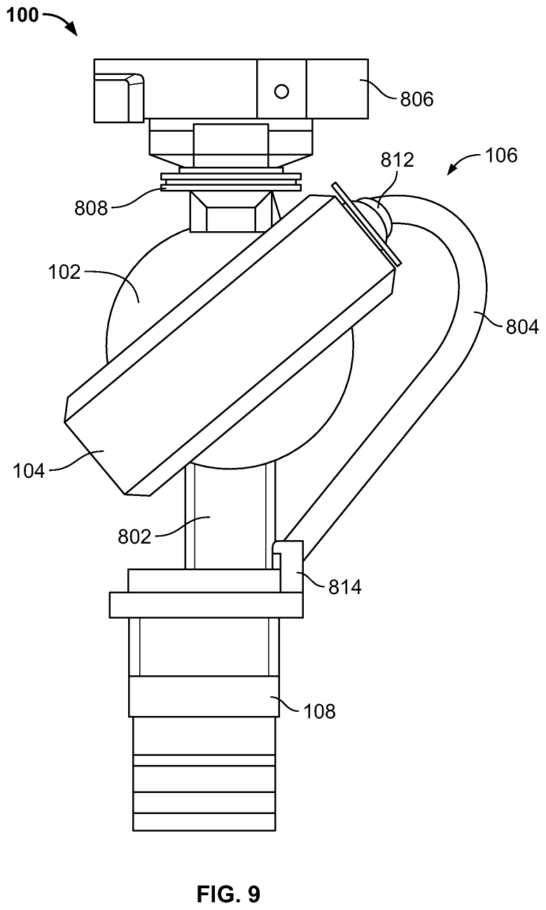

Turning now to FIGS. 8 and 9, in this embodiment the payload mount assembly 106 includes a bracket arm 802 and a lever arm 804. The bracket arm 802 is coupled to the spherical stator 102, to the armature 104, and to the payload 108. More specifically, at least in the depicted embodiment, the bracket arm 802 is rotationally coupled, via any one of numerous types of suitable non-illustrated hardware, to a mount plate 806 and to the payload 108. The mount plate 806, which is adapted to be fixedly mounted to a non-illustrated structure is also non-rotationally coupled, via suitable mounting hardware 808, to the spherical stator 102. Thus, when the armature 104 is caused to rotate about the second rotational axis 110-2, the payload mount assembly 106 (e.g., bracket arm 802 and lever arm 804), and thus the payload 108, also rotate about the second rotational axis 110-2.

The lever arm 804 is rotationally coupled, via suitable mounting hardware 812, to the armature 104, and is also rotationally coupled, via suitable mounting hardware 814, to the payload 108. Although the shape of the lever arm 804 may vary, it is, at least in the depicted embodiment, non-linearly shaped. The shape may be chosen, as may be appreciated, to effectuate a desired range of motion.

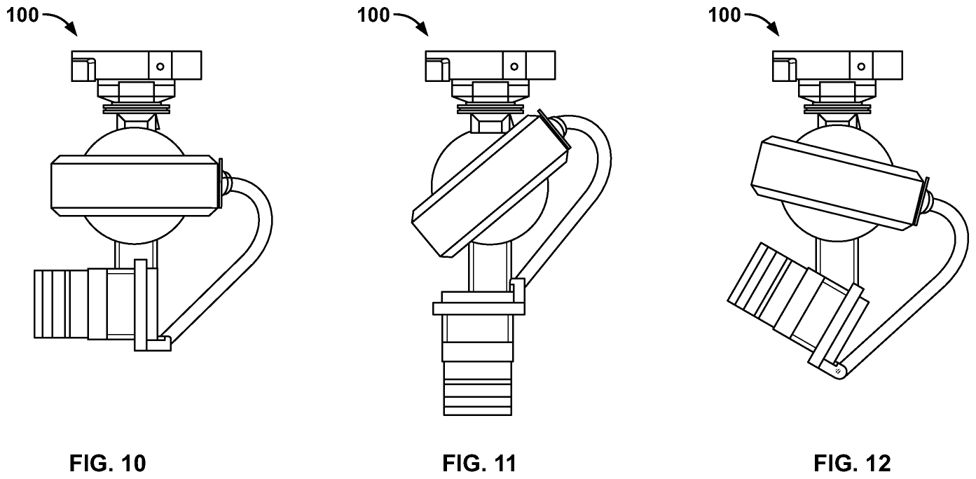

In the depicted embodiment, and as shown more clearly in FIGS. 10-12, the lever arm 804 is shaped such that when the armature 104 is rotated through 60-degrees of rotation about the first axis of symmetry 110-1 (e.g., from a reference position (FIG. 10) to 45-degrees in one rotational direction (FIG. 11) and to 15-degrees in the opposite rotational direction (FIG. 12)), the payload is rotated through 120-degrees of rotation about the payload rotational axis 112.

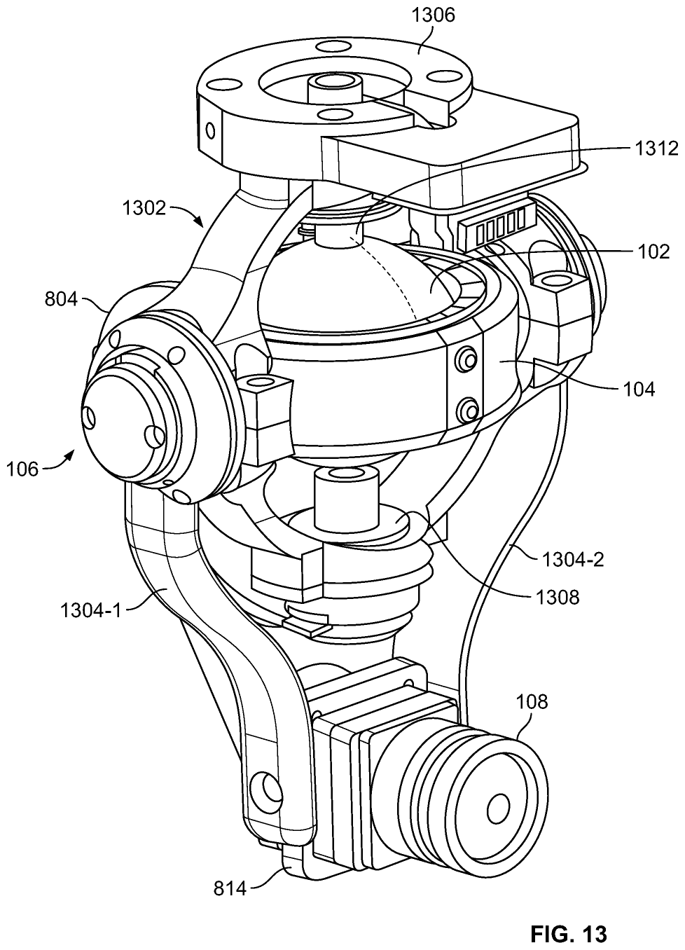

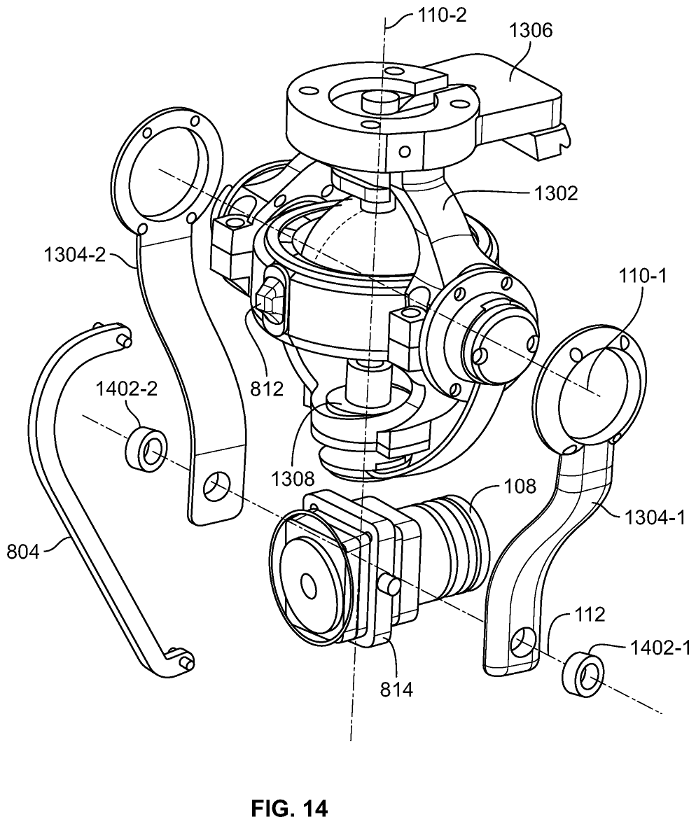

In yet another embodiment, which is depicted in FIGS. 13 and 14, the payload mount assembly 106 includes the lever arm 804 (and mounting hardware 812, 814) of the previously describe embodiment, and additionally includes a frame 1302 and a pair of support arms 1304—a first support arm 1304-1 and a second support arm 1304-2. The frame 1302 is coupled to the spherical stator 102 and to the armature 104. More specifically, at least in the depicted embodiment, the frame 1302 is rotationally coupled, via any one of numerous types of suitable non-illustrated hardware, to a mount plate 1306, and is rotationally coupled, via a suitable bearing assembly 1308, to the spherical stator 102. The mount plate 1306, which is adapted to be fixedly mounted to a non-illustrated structure is also non-rotationally coupled, via suitable mounting hardware 1312, to the spherical stator 102.

The first support arm 1304-1 is non-rotationally coupled, via suitable mounting hardware, to the frame 1302 and is rotationally coupled, via a first bearing 1402-1 (see FIG. 14), to a first side of the payload 108. The second support arm 1304-2 is also non-rotationally coupled, via suitable mounting hardware, to the frame 1302 and is rotationally coupled, via a second bearing 1402-2 (see FIG. 14) to a second side of the payload 108. wherein: the armature is rotatable relative to the frame about the first axis of symmetry, the frame is rotatable relative to the spherical stator about the second axis of symmetry.

The frame 1302 is rotationally coupled to the armature 104, via suitable mounting hardware, in a manner that allows the armature 104 to rotate, relative to the frame 1302, about the first axis of symmetry 110-1. With this configuration, when the armature 104 is caused to rotate about the second rotational axis 110-2, the payload mount assembly 106 (e.g., frame 1302, first arm 1304-1, second arm 1304-2, and lever arm 804), and thus the payload 108, also rotate about the second rotational axis 110-2. Moreover, and similar to previously described embodiment, the lever arm 804 is shaped such that when the armature 104 is rotated through 60-degrees of rotation about the first axis of symmetry 110-1 (e.g., from a reference position to 45-degrees in one rotational direction and to 15-degrees in the opposite rotational direction), the payload is rotated through 120-degrees of rotation about the payload rotational axis 112.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A multi-degree-of-freedom electromagnetic machine, comprising:
a spherical stator having a first axis of symmetry, a second axis of symmetry, a third axis of symmetry, the first, second, and third axes of symmetry disposed perpendicular to each other;
a first coil wound on the spherical stator about the first axis of symmetry;
a second coil wound on the spherical stator about the second axis of symmetry;
a third coil wound on the spherical stator about the third axis of symmetry;
an armature spaced apart from, and surrounding at least a portion of, the spherical stator, the armature mounted for rotation about the first axis of symmetry and second axis of symmetry;
a payload mount assembly coupled to the armature and to the spherical stator; and
a payload spaced apart from the spherical stator and the armature, and coupled to the payload mount assembly, the payload mounted to rotate, relative to at least a portion of the payload mount assembly, about a payload rotational axis, the payload rotational axis parallel to the first axis of symmetry and perpendicular to the second axis of symmetry, the payload disposed such that its center of gravity is at a position where the second axis of symmetry and the payload rotational axis intersect,
wherein:
the armature is rotatable relative to at least a portion of the payload mount assembly about the first axis of symmetry,
the armature and payload mount assembly are rotatable relative to the spherical stator about the second axis of symmetry,
when the armature rotates about the first axis of symmetry, the payload simultaneously rotates about the payload rotational axis, and
when the armature rotates about the second axis of symmetry, the payload mount assembly and the payload simultaneously rotate about the second axis of symmetry.

2. The multi-degree-of-freedom electromagnetic machine of claim 1, wherein the payload mount assembly comprises:
a bracket arm coupled to the spherical stator and to the armature;
a first pulley rotationally mounted on the bracket arm and coupled to the armature, the first pulley rotatable, relative to the bracket arm, about the first axis of symmetry;
a second pulley spaced apart from the first pulley and rotationally mounted on the bracket arm, the second pulley coupled to the payload and rotatable, relative to the bracket arm, about the payload rotational axis; and
a belt mounted on the first and second pulleys to transfer torque from the first pulley to the second pulley, whereby rotation of the first pulley about the first axis of symmetry causes rotation of the second pulley and the payload about the payload rotational axis.

3. The multi-degree-of-freedom electromagnetic machine of claim 2, wherein:
the first pulley has a first diameter;
the second pulley has a second diameter; and
the first diameter is greater than the second diameter.

4. The multi-degree-of-freedom electromagnetic machine of claim 2, further comprising:
a mount plate adapted to be fixedly mounted to a structure, the spherical stator non-rotationally coupled to the mount plate, the bracket arm rotationally coupled to the mount plate.

5. The multi-degree-of-freedom electromagnetic machine of claim 2, further comprising:
a shaft coupled to between the second pulley and the payload.

6. The multi-degree-of-freedom electromagnetic machine of claim 2, wherein the payload mount assembly is configured such that when the armature is rotated through 90-degrees of rotation about the first axis of symmetry, the payload is rotated through 180-degrees of rotation about the payload rotational axis.

7. The multi-degree-of-freedom electromagnetic machine of claim 1, wherein the payload mount assembly comprises:
a lever arm rotationally coupled to the armature and to the payload.

8. The multi-degree-of-freedom electromagnetic machine of claim 7, wherein the payload mount assembly further comprises:
a frame coupled to the spherical stator and to the armature;
a first support arm non-rotationally coupled the frame and rotationally coupled to a first side of the payload;
a second support arm non-rotationally coupled the frame and rotationally coupled to a second side of the payload;
wherein:
the armature is rotatable relative to the frame about the first axis of symmetry,
the frame is rotatable relative to the spherical stator about the second axis of symmetry.

9. The multi-degree-of-freedom electromagnetic machine of claim 6, wherein the lever arm is non-linearly shaped.

10. The multi-degree-of-freedom electromagnetic machine of claim 6, wherein the payload mount assembly is configured such that when the armature is rotated through 60-degrees of rotation about the first axis of symmetry, the payload is rotated through 120-degrees of rotation about the payload rotational axis.

11. A multi-degree-of-freedom electromagnetic machine, comprising:
a spherical stator having a first axis of symmetry, a second axis of symmetry, a third axis of symmetry, the first, second, and third axes of symmetry disposed perpendicular to each other;
a first coil wound on the spherical stator about the first axis of symmetry;
a second coil wound on the spherical stator about the second axis of symmetry;
a third coil wound on the spherical stator about the third axis of symmetry;
an armature spaced apart from, and surrounding at least a portion of, the spherical stator, the armature mounted for rotation about the first axis of symmetry and second axis of symmetry;
a bracket arm coupled to the spherical stator and to the armature;
a first pulley rotationally mounted on the bracket arm and coupled to the armature, the first pulley rotatable, relative to the bracket arm, about the first axis of symmetry;
a second pulley spaced apart from the first pulley and rotationally mounted on the bracket arm, the second pulley rotatable, relative to the bracket arm, about a payload rotational axis, the payload rotational axis parallel to the first axis of symmetry and perpendicular to the second axis of symmetry;
a belt mounted on the first and second pulleys to transfer torque from the first pulley to the second pulley, whereby rotation of the first pulley about the first axis of symmetry causes rotation of the second pulley and the payload about the payload rotational axis; and
a payload coupled to the second pulley and rotatable therewith about the payload rotational axis, the payload disposed such that its center of gravity is at a position where the second axis of symmetry and the payload rotational axis intersect,
wherein:
the armature is rotatable relative to the payload mount assembly about the first axis of symmetry,
the armature and bracket arm are rotatable relative to the spherical stator about the second axis of symmetry,
when the armature rotates about the first axis of symmetry, the payload simultaneously rotates about the payload rotational axis, and
when the armature rotates about the second axis of symmetry, the bracket arm and the payload simultaneously rotate about the second axis of symmetry.

12. The multi-degree-of-freedom electromagnetic machine of claim 11, wherein:
the first pulley has a first diameter;
the second pulley has a second diameter; and
the first diameter is greater than the second diameter.

13. The multi-degree-of-freedom electromagnetic machine of claim 11, further comprising:
a mount plate adapted to be fixedly mounted to a structure, the spherical stator non-rotationally coupled to the mount plate, the bracket arm rotationally coupled to the mount plate.

14. The multi-degree-of-freedom electromagnetic machine of claim 11, further comprising:
a shaft coupled to between the second pulley and the payload.

15. The multi-degree-of-freedom electromagnetic machine of claim 11, wherein:
when the armature is rotated through 90-degrees of rotation about the first axis of symmetry, the payload is rotated through 180-degrees of rotation about the payload rotational axis.

16. A multi-degree-of-freedom electromagnetic machine, comprising:
a spherical stator having a first axis of symmetry, a second axis of symmetry, a third axis of symmetry, the first, second, and third axes of symmetry disposed perpendicular to each other;
a first coil wound on the spherical stator about the first axis of symmetry;
a second coil wound on the spherical stator about the second axis of symmetry;
a third coil wound on the spherical stator about the third axis of symmetry;
an armature spaced apart from, and surrounding at least a portion of, the spherical stator, the armature mounted for rotation about the first axis of symmetry and second axis of symmetry;
a lever arm rotationally coupled to the armature; and
a payload spaced apart from the spherical stator and the armature, and rotationally coupled to the lever arm, the payload mounted to rotate about a payload rotational axis, the payload rotational axis parallel to the first axis of symmetry and perpendicular to the second axis of symmetry, the payload disposed such that its center of gravity is at a position where the second axis of symmetry and the payload rotational axis intersect,
wherein:
the armature is rotatable about the first axis of symmetry,
the armature and lever arm are rotatable relative to the spherical stator about the second axis of symmetry,
when the armature rotates about the first axis of symmetry, the payload simultaneously rotates about the payload rotational axis, and
when the armature rotates about the second axis of symmetry, the lever arm and the payload simultaneously rotate about the second axis of symmetry.

17. The multi-degree-of-freedom electromagnetic machine of claim 16, wherein the payload mount assembly further comprises:
a frame coupled to the spherical stator and to the armature;
a first support arm non-rotationally coupled the frame and rotationally coupled to a first side of the payload;
a second support arm non-rotationally coupled the frame and rotationally coupled to a second side of the payload;
wherein:
the armature is rotatable relative to the frame about the first axis of symmetry,
the frame is rotatable relative to the spherical stator about the second axis of symmetry.

18. The multi-degree-of-freedom electromagnetic machine of claim 16, wherein the lever arm is non-linearly shaped.

19. The multi-degree-of-freedom electromagnetic machine of claim 6, wherein:
when the armature is rotated through 60-degrees of rotation about the first axis of symmetry, the payload is rotated through 120-degrees of rotation about the payload rotational axis.
